(19) United States
(12) Patent Application Publication
(10) Pub. No.: US 2011/0012927 A1
(43) Pub. Date: Jan. 20, 2011

(54) TOUCH CONTROL METHOD

(75) Inventors: WEI-TE LIN, Tu-Cheng (TW); TE-HUA LEE, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/752,163

(22) Filed: Apr. 1, 2010

(30) Foreign Application Priority Data
Jul. 14, 2009 (CN) 200910304338.5

(51) Int. Cl. G09G 5/00

(52) U.S. Cl. 345/650; 345/661

(57) ABSTRACT

A touch control method for operating a touch screen includes: obtaining a to-be-operated object according to user's operations; detecting coordinates A(X_{A}, Y_{A}) of a first touch point with respect to the to-be-operated object on the touch screen; detecting coordinates B(X_{B}, Y_{B}) of an initial point of a second touch point; obtaining an operating center C(X_{C}, Y_{C}) according to the coordinates A(X_{A}, Y_{A}) and B(X_{B}, Y_{B}); detecting coordinates B′(X_{B′}, Y_{B′}) of the second touch point after the second touch point is moved; computing lengths of the two vectors CB and CB′ according to the coordinates C(X_{c}, Y_{C}), B(X_{B}, Y_{B}), and B′(X_{B′}, Y_{B′}), and computing a zoom coefficient K according to the lengths of the two vectors CB and CB′; and zooming in or out the to-be-operated object according to the zoom coefficient K around the operating center C(X_{C}, Y_{C}).

### BACKGROUND

1. Technical Field

The present disclosure relates to touch screens, and particularly to a touch control method for operating the touch screens.

2. Description of Related Art

Touch screens are widely used in electronic devices to act as input and output devices. In order to zoom in or out a selected object, a user commonly clicks or touches an icon displayed on the touch screens.

However, it is constraining that a user can only zoom in or out the selected object by clicking the icons. Therefore, improved touch control methods are desired.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a touch screen on which a coordinate system is defined in accordance with an exemplary embodiment.

FIG. 2 is a flow chart of a touch control method in accordance with an exemplary embodiment.

### DETAILED DESCRIPTION

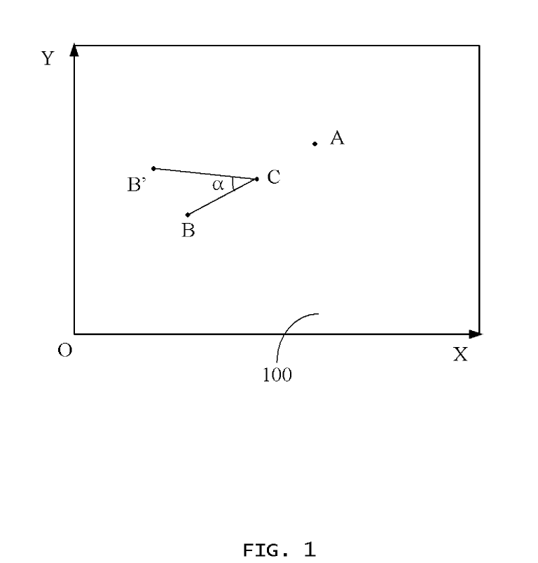

A touch screen can be operable to detect positions of touch inputs on the touch screen. The touch screen may detect the touch inputs using any of a plurality of touch sensitive technologies, including, but not limited to capacitive, resistive, infrared, and surface acoustic wave technologies. Referring to FIG. 1, to be easier understood, it is illustrated that a touch screen 100 is rectangular. A rectangular coordinate system is defined on the touch screen 100. Origin O of the coordinate system is defined at one end of the touch screen 100. X-axis and Y-axis of the coordinate system extend along two edges connected to the origin O respectively. As such, each point of the touch screen has fixed coordinates.

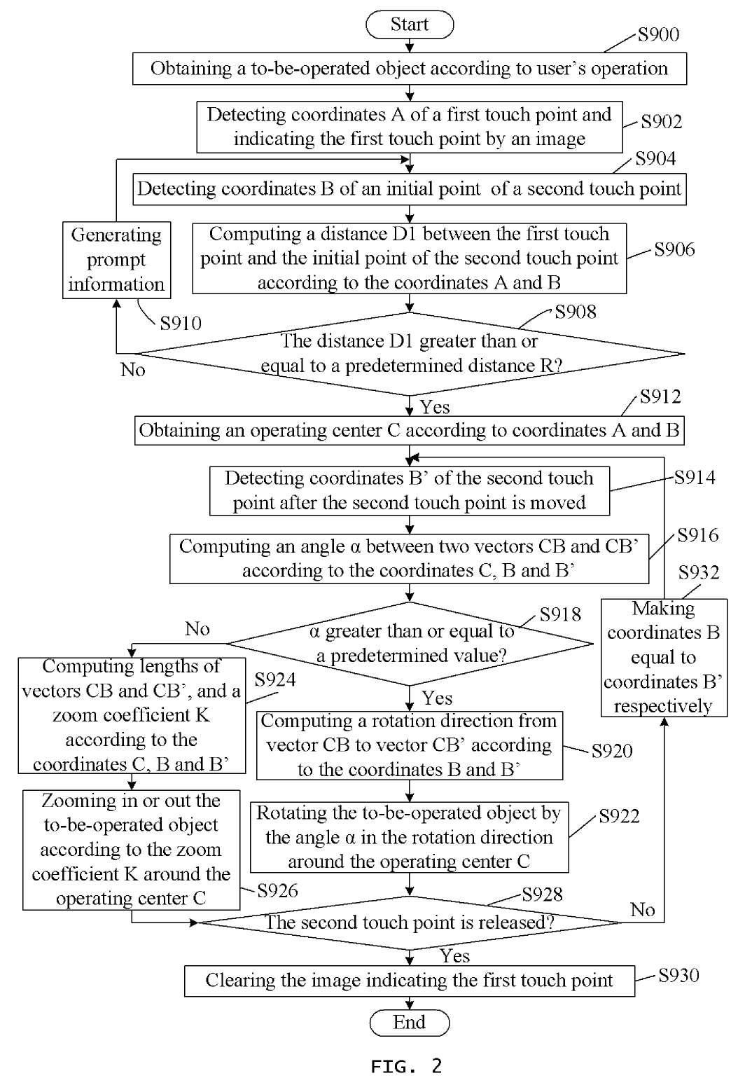

Referring also to FIG. 2, a touch control method, is provided based on the position detecting technology used in the touch screen 100 described above. The touch control method can enhance flexibility for a user that operates the touch screen 100. The touch control method includes the following steps.

In step S900, obtaining a to-be-operated object according to the user's operations. In detail, if the user selects an area or an object displayed on the touch screen 100, the selected area or the selected object is the to-be-operated object. If the user does not select any area or object displayed on the touch screen 100, all objects displayed on the touch screen 100 are the to-be-operated object. In the embodiment, the to-be-operated object may be an image or an icon displayed on the touch screen 10.

In step S902, detecting coordinates A(X_{A}, Y_{A}) of a first touch point. The first touch point is a fixed point. In the embodiment, the first touch point is obtained by means of double clicking, that is, when the user double clicks the same point in a first predetermined period, the double clicked point is used as the first touch point. The first predetermined period may be 1 second. To be easily operated by the user, the first touch point is indicated by an image, such as a red dot, displayed on the touch screen 100.

In step S904, detecting coordinates B(X_{B}, Y_{B}) of an initial point of a second touch point. The second touch point is a moving point. Touching can obtain the second touch point. In the embodiment, in a second predetermined period after the first touch point is obtained, if the user touches the touch screen 100 again, the touched point is used as the initial point of the second touch point. The second predetermined period may be 1 second.

In step S906, computing a distance D1 between the first touch point and the initial point of the second touch point according to the coordinates A(X_{A}, Y_{A}) and B(X_{B}, Y_{B}). In the embodiment, the distance D1 can be computed according to the following equation (1):

D1=\sqrt{(X_{B}−X_{A})²+(Y_{B}−Y_{A})²}. (1).

In step S908, determines whether the distance D1 is greater than or equal to a predetermined distance R. If the distance D1 is greater than or equal to the predetermined distance R, step S912 is implemented. If the distance D1 is less than the predetermined distance R, step S910 is implemented.

In step S910, generating prompt information to remind the user that the initial point of the second touch point is invalid, and allowing the user to input the initial point of the second touch point again, and step S904 is further implemented. The prompt information may be image information, audio information, etc.

In step S912, obtaining an operating center C(X_{C}, Y_{C}) according to the coordinates A(X_{A}, Y_{A}) and B(X_{B}, Y_{B}). The operating center C(X_{C}, Y_{C}) can be computed using a predetermined formula according to requirements of the user. In the embodiment, the operating center C(X_{C}, Y_{C}) may be a middle point of a line segment between the first touch point and the initial point of the second touch point, the predetermined formula may be X_{C}=(X_{A}+X_{B})/2, Y_{C}=(Y_{A}+Y_{B})/2. In other embodiments, the operating center C(X_{C}, Y_{C}) may only be computed according to the coordinates A(X_{A}, Y_{A}), such as the operating center C(X_{C}, Y_{C}) is the first touch point, the predetermined formula may be X_{C}=X_{A}, Y_{C}=Y_{A}.

In step S914, detects the coordinates B′ (X_{B′}, Y_{B′}) of the second touch point after the second touch point is moved.

In step S916, computing an angle α between two vectors CB and CB′ according to the coordinates C(X_{C}, Y_{C}), B(X_{B}, Y_{B}), and B′(X_{B′}, Y_{B′}). In the embodiment, the angle α can be computed according to the following equation (2):

$$α = {COS}^{- 1} ( \frac{( {X}_{{B}^{′}} - {X}_{C} ) * ( {X}_{B} - {X}_{C} ) + ( {Y}_{{B}^{′}} - {Y}_{C} ) * ( {Y}_{B} - {Y}_{C} )}{\sqrt{{( {X}_{B} - {X}_{C} )}^{2} + {( {Y}_{B} - {Y}_{C} )}^{2}} * \sqrt{{( {X}_{{B}^{′}} - {X}_{C} )}^{2} + {( {Y}_{{B}^{′}} - {Y}_{C} )}^{2}}} ) . \qquad ( 2 )$$

In step S918, determining whether the angle α is greater than or equal to a predetermined value. If the angle α is greater than or equal to the predetermined value, step S920 is implemented. If the angle α is less than the predetermined value, step S924 is implemented. In the embodiment, the predetermined value is 2 degrees.

In step S920, computing a rotation direction from the vector CB to the vector CB′ according to the coordinates B(X_{B}, Y_{B}) and B′(X_{B′}, Y_{B′}). In the embodiment, the rotation direction is determined via comparing the Y_{B} and Y_{B′}. If Y_{B′} is greater than Y_{B}, the rotation direction is clockwise. If Y_{B′} is less than Y_{B}, the rotation direction is counter-clockwise. If Y_{B′} is equal to Y_{B}, the rotation direction is determined via comparing the X_{B′} and X_{B}. If X_{B′} is greater than X_{B}, the rotation direction is counter-clockwise. If X_{B′} is less than X_{B}, the rotation direction is clockwise.

In step S922, rotating the to-be-operated object by the angle α in the rotation direction around the operating center C(X_{C}, Y_{C}).

In step S924, computing lengths of the two vectors CB and CB′ according to the coordinates C(X_{C}, Y_{C}), B(X_{B}, Y_{B}), and B′(X_{B′}, Y_{B′}), and computing a zoom coefficient K according to the lengths of the two vectors CB and CB′. The zoom coefficient K can be computed using a predetermined formula according to requirements of the user. In the embodiment, the zoom coefficient K can be computed according to the following equation (3):

$$K = ( \frac{\sqrt{{( {X}_{{B}^{′}} - {X}_{C} )}^{2} + {( {Y}_{{B}^{′}} - {Y}_{C} )}^{2}}}{\sqrt{{( {X}_{B} - {X}_{C} )}^{2} + {( {Y}_{B} - {Y}_{C} )}^{2}}} ) . \qquad ( 3 )$$

In step S926, zooming in or out the to-be-operated object according to the zoom coefficient K around the operating center C(X_{C}, Y_{C}).

In step S928, determining whether the second touch point is released. If the second touch point is released, step S930 is implemented. If the second touch point is not released, step S932 is implemented.

In step S930, clearing the image indicating the first touch point.

In step S932, making the coordinates B(X_{B}, Y_{B}) equal to coordinates B′(X_{B′}, Y_{B′}) respectively, that is, Y_{B}=Y_{B′}, and X_{B}=X_{B′}; and step S914 is further implemented.

Using the touch control method, the to-be-operated object zooms in real-time according to a movement path of the second touch point, thus zooms of the to-be-operated object are intuitionistic, and it is more flexible for user's operations.

To be easily operated by the user, the movement path of the second touch point also can be indicated by an image, and the image indicating the second touch point is cleared when the second touch point is released.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A touch control method for operating a touch screen, the touch control method comprising:
obtaining a to-be-operated object according to user's operations;
detecting coordinates A(X_{A}, Y_{A}) of a first touch point with respect to the to-be-operated object on the touch screen;
detecting coordinates B(X_{B}, Y_{B}) of an initial point of a second touch point;
obtaining an operating center C(X_{C}, Y_{C}) according to the coordinates A(X_{A}, Y_{A}) and B(X_{B}, Y_{B});
detecting coordinates B′(X_{B′}, Y_{B′}) of the second touch point after the second touch point is moved;
computing lengths of the two vectors CB and CB′ according to the coordinates C(X_{C}, Y_{C}), B(X_{B}, Y_{B}), and B′(X_{B′}, Y_{B′}), and computing a zoom coefficient K according to the lengths of the two vectors CB and CB′; and
zooming in or out the to-be-operated object according to the zoom coefficient K around the operating center C(X_{C}, Y_{C}).

2. The touch control method according to claim 1, wherein the zoom coefficient K is computed by following equation:
$$K = ( \frac{\sqrt{{( {X}_{{B}^{′}} - {X}_{C} )}^{2} + {( {Y}_{{B}^{′}} - {Y}_{C} )}^{2}}}{\sqrt{{( {X}_{B} - {X}_{C} )}^{2} + {( {Y}_{B} - {Y}_{C} )}^{2}}} ) .$$

3. The touch control method according to claim 1, further comprising:
computing a distance D1 between the first touch point and the initial point of the second touch point according to the coordinates A(X_{A}, Y_{A}) and B(X_{B}, Y_{B});
determining whether the distance D1 is greater than or equal to a predetermined distance R; and
if the distance D1 is greater than or equal to the predetermined distance R, the step that obtaining the operating center C(X_{C}, Y_{C}) according to the coordinates A(X_{A}, Y_{A}) and B(X_{B}, Y_{B}) is further implemented.

4. The touch control method according to claim 3, further comprising:
if the distance D1 is less than the predetermined distance R, generating prompt information to remind the user that the initial point of the second touch point is invalid, and allowing the user to input the initial point of the second touch point again, and the step that detecting coordinates B(X_{B}, Y_{B}) of the initial point of the second touch point is further implemented.

5. The touch control method according to claim 1, further comprising:
determining whether the second touch point is released; and
if the second touch point is not released, making the coordinates B(X_{B}, Y_{B}) equal to coordinates B′(X_{B′}, Y_{B′}), and the step that detecting the coordinates B′(X_{B′}, Y_{B′}) of the second touch point after the second touch point is moved is further implemented.

6. The touch control method according to claim 5, further comprising:
indicating the first touch point by an image when coordinates A(X_{A}, Y_{A}) of the first touch point are detected; and
clearing the image indicated the first touch point if the second touch point is released.

7. The touch control method according to claim 5, further comprising:
indicating a movement path of the second touch point by an image; and
clearing the image indicating the second touch point when the second touch point is released.

8. The touch control method according to claim 1, wherein the operating center C(X_{C}, Y_{C}) is a middle point of a line segment between the first touch point and the initial point of the second touch point, where X_{C}=(X_{A}+X_{B})/2, Y_{C}=(Y_{A}+Y_{B})/2.

9. The touch control method according to claim 1, further comprising:
computing an angle α between two vectors CB and CB′ according to the coordinates C(X_{C}, Y_{C}), B(X_{B}, Y_{B});
determining whether the angle α is greater than or equal to a predetermined value; and
if the angle α is less than the predetermined value, the step that computing the lengths of the two vectors CB and CB′ according to the coordinates C(X_{C}, Y_{C}), B(X_{B}, Y_{B}), and B′(X_{B′}, Y_{B′}), and computing the zoom coefficient K according to the lengths of the two vectors CB and CB′ is implemented.

10. The touch control method according to claim 9, further comprising:
if the angle α is greater than or equal to the predetermined value, computing a rotation direction from the vector CB to the vector CB′ according to the coordinates B(X_{B}, Y_{B}) and B′(X_{B′}, Y_{B′}); and
rotating the to-be-operated object by the angle α in the rotation direction around the operating center.

11. A touch control method for operating a touch screen, the touch control method comprising:
obtaining a to-be-operated object according to user's operations;
detecting coordinates A(X_{A}, Y_{A}) of a first touch point;
detecting coordinates B(X_{B}, Y_{B}) of an initial point of a second touch point;
obtaining an operating center C(X_{C}, Y_{C}) according to coordinates A(X_{A}, Y_{A});
detecting coordinates B′(X_{B′}, Y_{B′}) of the second touch point after the second touch point is moved;
computing lengths of the two vectors CB and CB′ according to the coordinates C(X_{C}, Y_{C}), B(X_{B}, Y_{B}), and B′(X_{B′}, Y_{B′}), and computing a zoom coefficient K according to the lengths of the two vectors CB and CB′; and
zooming in or out the to-be-operated object according to the zoom coefficient K around the operating center C(X_{C}, Y_{C}).

12. The touch control method according to claim 11, wherein the zoom coefficient K is computed by following equation:
$$K = ( \frac{\sqrt{{( {X}_{{B}^{′}} - {X}_{C} )}^{2} + {( {Y}_{{B}^{′}} - {Y}_{C} )}^{2}}}{\sqrt{{( {X}_{B} - {X}_{C} )}^{2} + {( {Y}_{B} - {Y}_{C} )}^{2}}} ) .$$

13. The touch control method according to claim 11, further comprising:
computing a distance D1 between the first touch point and the initial point of the second touch point according to the coordinates A(X_{A}, Y_{A}) and B(X_{B}, Y_{B});
determining whether the distance D1 is greater than or equal to a predetermined distance R; and
if the distance D1 is greater than or equal to the predetermined distance R, the step that obtaining the operating center C(X_{C}, Y_{C}) according to the coordinates A(X_{A}, Y_{A}) is further implemented.

14. The touch control method according to claim 13, further comprising:
if the distance D1 is less than the predetermined distance R, generating prompt information to remind the user that the initial point of the second touch point is invalid, and allowing the user to input the initial point of the second touch point again, and the step that detecting the coordinates B(X_{B}, Y_{B}) of the initial point of the second touch point is further implemented.

15. The touch control method according to claim 11, further comprising:
determining whether the second touch point is released; and
if the second touch point is not released, making the coordinates B(X_{B}, Y_{B}) equal to coordinates B′(X_{B′}, Y_{B′}), and the step that detecting coordinates B′(X_{B′}, Y_{B′}) of the second touch point after the second touch point is moved is further implemented.

16. The touch control method according to claim 15, further comprising:
indicating the first touch point by an image when coordinates A(X_{A}, Y_{A}) of the first touch point are detected; and
clearing the image indicated the first touch point if the second touch point is released.

17. The touch control method according to claim 15, further comprising:
indicating a movement path of the second touch point by an image; and
clearing the image indicating the second touch point when the second touch point is released.

18. The touch control method according to claim 11, wherein the operating center C(X_{C}, Y_{C}) is the first touch point, where X_{C}=(X_{A}+X_{B})/2, Y_{C}=(Y_{A}+Y_{B})/2.

19. The touch control method according to claim 11, further comprising:
computing an angle α between two vectors CB and CB′ according to the coordinates C(X_{C}, Y_{C}), B(X_{B}, Y_{B});
determining whether the angle α is greater than or equal to a predetermined value; and
if the angle α is less than the predetermined value, step that computing the lengths of the two vectors CB and CB′ according to the coordinates C(X_{C}, Y_{C}), B(X_{B}, Y_{B}), and B′ (X_{B′}, Y_{B′}), and computing the zoom coefficient K according to the lengths of the two vectors CB and CB′ is implemented.

20. The touch control method according to claim 19, further comprising:
if the angle α is greater than or equal to the predetermined value, computing a rotation direction from the vector CB to the vector CB′ according to the coordinates B(X_{B}, Y_{B}) and B′(X_{B′}, Y_{B′}); and
rotating the to-be-operated object by the angle α in the rotation direction around the operating center.
